(19) United States
(12) Patent Application Publication
(10) Pub. No.: US 2014/0183778 A1
(43) Pub. Date: Jul. 3, 2014

(54) METHOD FOR MAKING A STRUCTURE FOR RESUMING CONTACT

(71) Applicants: STMICROELECTRONICS (CROLLES 2) SAS, Crolles (FR); COMMISSARIAT A L'ENERGIE ATOMIQUE ET AUX ENE ALT, Paris (FR)

(72) Inventors: Jean-Philippe COLONNA, Grenoble (FR); Christophe AUMONT, Le Touvet (FR); Stefan LANDIS, Voiron (FR)

(73) Assignees: STMICROELECTRONICS (CROLLES 2) SAS, Crolles (FR); COMMISSARIAT A L'ENERGIE ATOMIQUE ET AUX ENE ALT, Paris (FR)

(21) Appl. No.: 14/108,940

(22) Filed: Dec. 17, 2013

(30) Foreign Application Priority Data
Dec. 27, 2012 (FR) 12 62851

(51) Int. Cl. H01H 1/00

(52) U.S. Cl. CPC H01H 1/00
USPC 264/104; 425/385

(57) ABSTRACT

A method for making a conducting structure comprising steps of:
forming on a given face of the support comprising at least one conducting element, at least one area for absorbing stresses based on a dielectric material,
forming at least one aperture in said dielectric material by applying a mold on said dielectric material, said aperture being provided with inclined walls relatively to a normal to the main plane of said support, the bottom of said aperture revealing said conducting element,
filling said aperture with a conducting material.

### TECHNICAL FIELD

The present invention relates to the field of microelectronics and/or nanoelectronics and microsystems and/or nanosystems, and in particular concerns that of the making of contacting structures.

It more generally applies to the making of conducting structures formed on a support and surrounded by means for isolating and absorbing stresses formed in a layer of dielectric material.

### STATE OF THE PRIOR ART

In order to make electronic devices described as [symbol] 3D [symbol] devices, comprising a plurality of stacked substrates or components or chips, the application of interconnecting structures in the form of so-called vias or [symbol] TSVs [symbol] ( [symbol] Through Silicon Vias [symbol] ) formed with a conducting element crossing the thickness of one or several substrates or of one or several chips. TSVs give the possibility of making a connection between an element located on a face called [symbol] front face [symbol] or on the side of the front face of a substrate and another element located on another face called [symbol] rear face [symbol] or on the side of the rear face of the said substrate.

On the face of a substrate through which opens a TSV, a structure is generally made, comprising a conducting area extending along the space, which is commonly called a contacting structure.

In this type of structure, stresses due to a thermal expansion coefficient (TEC) difference between the various materials used, notably copper and silicon, may be generated.

In order to overcome this problem, providing encapsulation of the contacting structure areas is known by means of a layer for absorbing stresses.

Such a layer may also be used for allowing absorption of the generated mechanical stresses notably during the assembling of chips, in particular, if a thermocompression technique is used.

The problem is posed of finding a novel method for making a contacting structure.

### DISCUSSION OF THE INVENTION

The present invention according to a first aspect relates to a method for making at least one structure comprising a conducting area positioned on one face of the support, the method comprising steps consisting of:

a) forming on a given face of said support including at least one portion of a conducting element, at least one area based on a dielectric material on said conducting element,

b) forming in said dielectric material, at least one first block of dielectric material including a first cavity provided with inclined walls relatively to a normal to the main plane of said support and a bottom revealing said conducting element, step b) being carried out at least by applying a mold on said dielectric material area,

c) filling said cavity with a conducting material so as to form a conducting area in the extension of said conducting element.

The structure made may be a contacting structure.

The first dielectric material block acts as an area for absorbing stresses generated by said filling conducting material in step c). This block is thus base on a stress-absorbing dielectric material, for example such as a stress-absorbing polymer.

Inclined slopes for the conducting area and the dielectric material block formed around this area give the possibility of achieving efficient distribution of the stresses.

According to the invention step b) is carried out by means of an embossing mold also called a [symbol] nano-imprint [symbol] , the geometrical characteristics of which are adapted so as to allow a cavity to be made with inclined walls.

Such a mold may allow a cavity to be made with inclined walls with a greater tilt angle than with a method using photolithography.

Such a mold may allow a cavity to be made having a mouth and a bottom with smaller cross-section than that of the mouth.

The mold may thus be in the form of another support having at least a given protruding pattern, said given pattern including inclined flanks, the tilt of which corresponds to that of the walls of the cavity. The given pattern may further have variable cross-section decreasing from its base to its top.

The shape of this given pattern of the mold may thus conform to that of said first cavity.

The given pattern of the mold may for example have a conical or frusto-conical shape or reproducing a pyramid section. Thus, it is for example possible to make in the dielectric material a cavity of conical or frusto-conical shape or with a pyramid section.

The given pattern of the mold may have a height equal to the depth of the first cavity.

Such a mold may optionally include several patterns having flanks of different tilts.

Thus, it is possible to make in the dielectric material one or several cavities having walls with different tilts.

According to a possibility of applying the method, the mold used in step b) may include suitable patterns for printing in a single step several cavities of different depths and/or including flanks of different tilts.

Such a mold may thus include several patterns having flanks of different tilts and/or of different heights.

The conducting area made on said first conducting element may be intended to be connected with an element for connecting another support or chip positioned facing said given face or further to a conducting region positioned on said given face for example in the case when one or several electric redistribution lines are formed.

The first conducting element may for example be a via of the TSV type.

The first conducting element may at least partly cross the thickness of said support and include an end flush with said given face of the support or jutting out from said given face of the support.

The first conducting element may optionally include an end opening onto a face of the support opposite to said given face.

According to a possibility of application for which said first conducting element crosses at least partly the thickness of said support, the method may further comprise, before step a), a step for removing a thickness of the support at said given face, so as to release said end from said first conducting element.

It is thus possible to make a conducting area in the extension of said TSV element which is found at a distance from the given face of the support and to provide an area of a stress-absorbing dielectric material between this conducting area and the lower face of the support.

This gives the possibility of achieving a contacting structure in which the stresses are further reduced.

According to a possibility for applying this method, wherein, in step a), said given face of the support includes at least one portion of a second conducting element, the application of the mold in step b) may be achieved so that at least one second block of dielectric material includes at least one second cavity revealing said second conducting element.

Thus, the step c) for filling said other cavity by means of the conducting material may lead to formation of another conducting area in the extension of said second conducting element.

According to a possibility for applying the method, the application of the mold in step b) may be achieved so that said first block of dielectric material and said second block of dielectric material belong to a same area of dielectric material or are separated by an empty space.

According to a possibility of applying the method, the first cavity and the second cavity have lower portions separated by said dielectric material and upper portions which communicate with each other.

The application of a mold thus gives the possibility of achieving a gain in steps as compared with an embodiment with photolithography.

The application of the mold in step b) may be such that said first block of dielectric material and said second block of dielectric material have different dimensions from each other.

Said first block and said second block of dielectric material may have different heights and/or thicknesses and/or widths.

Depending on the distribution of the stresses on the support, it is possible to provide the formation of blocks of dielectric material with a thickness and/or a greater height at the location of the support where the stresses are larger and formation of the blocks of dielectric material with lesser thickness and/or height at the locations of the support where the stresses are smaller, and where it is sought to have a larger integration density for example.

According to a possibility for applying the method, the application of the mold in step b) may be such that said first block of dielectric material and said second block of dielectric material have inclined flanks relatively to a normal to the main plane of said support, the tilt of the flanks of said first block being different from that of the flanks of said second block of dielectric material.

Also, the tilt of the flanks of the blocks of dielectric material may further be adapted depending on the exerted stresses.

According to a possibility for applying the method, between step b) and step c) a germination layer may be formed on the wall and the bottom of said cavity, step c) being carried out by growth on the germination layer.

The tilt of the walls of the cavity may then give the possibility of facilitating the formation of this layer.

According to another aspect, the present invention relates to an embossing mold adapted for carrying out step b) of a method as defined above.

This embossing mold or [symbol] nano-imprint [symbol] may be in the form of another support, for example a plate having at least one given pattern protruding on said other support, said given pattern having a cross-section decreasing from its base to its top as well as flanks inclined relatively to a normal to a main plane of said other support.

According to a possible embodiment, the embossing mold may have at least one other protruding pattern, said other pattern including flanks with a tilt different from the flanks of said given pattern, and/or different dimensions from those of said given pattern.

The present invention also relates to an interconnection structure between a front face and a rear face of a support, comprising on or above a given face of the support, at least one conducting area housed in an aperture made in a dielectric material for absorbing stresses, said aperture being provided with inclined walls relatively to a normal to the main plane of said support, the conducting area having inclined flanks fitting the shape of at least one block based on said dielectric material, said conducting area being also connected to a conducting element opening onto one face of the support opposite to said given face.

### SHORT DESCRIPTION OF THE DRAWINGS

The present invention will be better understood upon reading the description of given exemplary embodiments, purely as an indication and by no means as a limitation, with reference to the appended drawings wherein:

FIGS. 1A-1E, illustrating a first exemplary method according to the invention, for making a structure for resuming contact in which a conducting area with inclined flanks and which is formed on a TSV, is surrounded by a stress-absorbing dielectric material area, the dielectric material area having inclined flanks fitting those of the conducting area;

FIG. 2 illustrates an embossing mold for forming patterns with inclined flanks in a stress-absorbing dielectric material during a method according to the invention;

FIG. 3 illustrates a structure for resuming contact obtained by means of the method according to the invention;

FIGS. 4A-4E illustrate an alternative of the first exemplary method;

FIGS. 5A-5D illustrate another exemplary method in contacting structure is made on through-vias, the contacting structure being formed with a horizontal conducting line surmounted with a pad of hemispherical shape;

FIGS. 6A-6B, illustrate steps for making a nucleation layer with view to forming a conducting area surmounting through-vias when making an interconnection structure according to the invention;

FIG. 7 illustrates an interconnection structure according to the invention comprising an area for resuming contact in the front face of the substrate and in which a conducting area with inclined flanks is surrounded by a stress-absorbing dielectric material area, the dielectric material area having inclined flanks fitting those of the conducting area;

FIGS. 8 and 9 illustrate alternative embodiments of structures applied by means of the method implemented according to the invention;

FIG. 10 illustrates a nano-imprint mold for forming patterns for isolating and absorbing stresses as illustrated in FIG. 9.

Identical portions, similar or equivalent to the various figures bear the same numerical references so as to facilitate the passing from one figure to the other.

The different portions illustrated in the figures are not necessarily illustrated according to a uniform scale, in order to make the figures more legible.

### DETAILED DISCUSSION OF PARTICULAR EMBODIMENTS

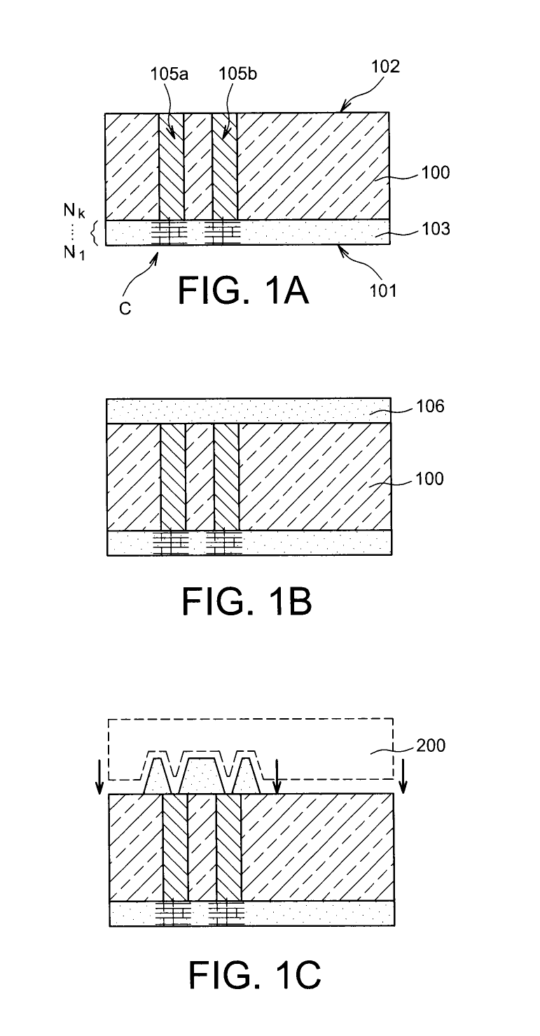

A first exemplary method, according to the invention for making a microelectronic device provided with a contacting structure, will now be described in connection with FIGS. 1A-1E.

The starting material of this method (FIG. 1A) may be a support 100 formed with a semi-conducting substrate, for example based on Si, provided with at least one circuit C and metal levels N₁, . . . , Nₖ of interconnections of components of the circuit positioned in an insulating layer 103, each metal level may comprise a plurality of horizontal metal lines, vertical metal areas or vias being provided for connecting the horizontal metal lines with each other.

Conducting elements 105a, 105b commonly called TSVs cross the thickness of the substrate 100, and open onto the lower face of the support also called a [symbol] rear face [symbol] 102 opposite to the upper face also called a [symbol] front face [symbol] 101.

The conducting elements 105a, 105b, are connected to the interconnection metal levels and give the possibility of establishing an electric connection between elements positioned on the upper face 101 and the lower face 102 of the support 100.

Next, a layer of dielectric material 106 is formed on the rear face 102 for example by spin coating (FIG. 1B).

The dielectric material 106 is a material provided for playing the role of a stress absorber ( [symbol] stress buffer [symbol] ).

For this, the dielectric material 106 may for example be a polymeric material.

The dielectric material 106 may in particular be selected so as to have a Young modulus comprised for example between 2 GPa and 60 GPa. The dielectric material 106 may also be selected so as to have a low thermal expansion coefficient (TEC) for example of less than 60 ppm.

The thickness of deposited dielectric material 106 may for example be comprised between 2 μm and 12 μm.

The dielectric material 106 may also be a material selected in particular in order to have high temperature stability, for example of at least 300° C.

The dielectric material 106 may also be selected so as to be able to be cleaned at a low temperature, for example below 200° C.

The dielectric material 106 may also be selected so as to have a dielectric constant of the order of 3 or 4 for example.

The dielectric material 106 may also be a material having a glass transition temperature Tg of less than 160° C.

The dielectric material 106 may also be selected with a low shrinking factor, in particular of less than 10% and a large elongation factor, for example greater than 20%.

The dielectric material 106 may for example be a polymer of a type available under reference ALX2010 from Asahi Glass Inc. or the one available under reference PB08930 from HD MicroSystems. Alternatively, the dielectric material 106 may be a silicon oxide for example deposited with a spreading method by centrifugation commonly called [symbol] SOG [symbol] (for [symbol] Spin On Glass≅).

| | ALX2010 | PBO8930 | SiO₂ (SOG) |
|---|---|---|---|
| Young modulus (GPa) | 2.6-2.7 | 1.8 | 70 |
| Elongation (%) | 20 | 80 | 0 |
| TEC (ppm/° C.) | 62 | 80 | 0.5 |
| Stress (MPa) | 32 | 25 | −70 |
| Dielectric constant | 2.6 | 3.1 | 5-6 |

Next (FIG. 1C), patterns are formed in the dielectric material 106 by a printing technique commonly called embossing or [symbol] imprint [symbol] or [symbol] nano-imprint [symbol] , by means of a mold 200, for example based on Si or quartz, itself provided with patterns which have just been applied on the dielectric material 106 layer in order to form complementary patterns in this material 106.

Alignment windows, for example in the form of apertures made in the mold may be provided and placed facing alignment marks of the support 100.

The application of the mold 200 may be accompanied by a provision of heat, as this is achieved for example in the document “Imprint of sub 25 nm vias and trenches in polymers” Stephen Y. Chou, Peter R. Krauss, and Preston J. Renstrom Appl. Phys. Lett. 67, 3114 (1995) or else achieved under UV radiation as this is for example achieved in the document “Patterning curved surfaces: Template generation by ion beam proximity lithography and relief transfer by step and flash imprint lithography” P. Ruchhoeft, M. Colburn, B. Choi, H. Nounu, S. Johnson, T. Bailey, S. Damle, M. Stewart, J. Ekerdt, S. V. Sreenivasan, J. C. Wolfe, C. G. Willson, J. Vac. Sci. Technol., November/December 2965 (1999).

The patterns of the mold 200 may have a size or a critical dimension of the order of one or several tens of nanometers or of one or several hundred nanometers or several micrometers.

This technique thus allows patterns to be made according to a significant range of dimensions, while being inexpensive to apply.

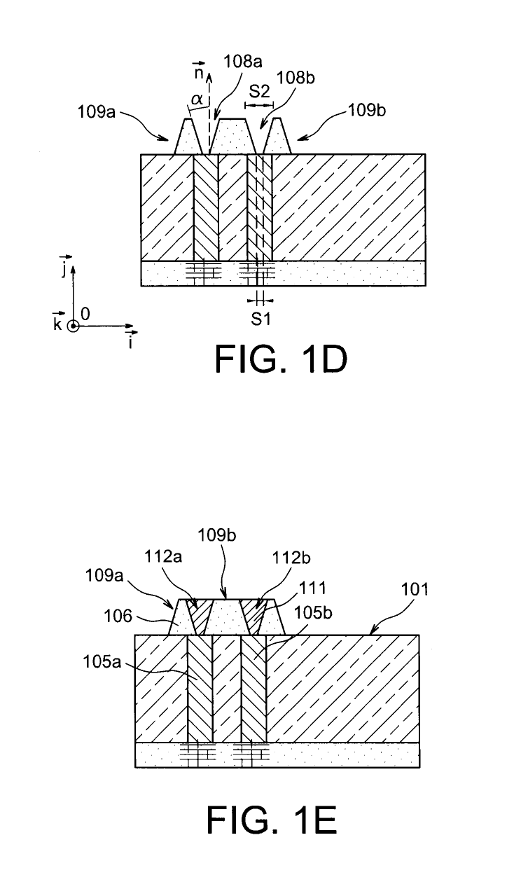

FIG. 2 illustrates a particular example of a mold portion 200 which may be in the form of a plate including a pattern 210 with a cross-section (the cross-section being taken parallel to the plane [O; \vec{i}; \vec{k}] of the orthogonal reference system [\vec{i}; \vec{j}; \vec{k}]), for example of truncated shape with flanks inclined according to a non-zero angle θ, which may be less than 45°, for example of the order of 35° relatively to a normal \vec{n} to the main plane of the plate (the main plane of the plate being defined in FIG. 2 as a plane passing through the plate and which is parallel to the plane [O; \vec{i}; \vec{k}] of the orthogonal reference system [O; \vec{i}; \vec{j}; \vec{k}]).

The pattern 210 illustrated in FIG. 2 may have a height h of the order of several micrometers, for example of the order of 4 μm, a base forming a disc of diameter a₁ for example of the order of 3 μm and a top forming a disc of diameter a₂ for example of the order of 6 μm. The pattern 210 of frusto-conical shape is here surrounded by a trench 211 made in the plate 200. This trench 211 forms a closed contour, for example in the form of a circular ring, around the frusto-conical pattern 210. This ring may for example have an outer diameter of the order of 10 μm. The trench 211 is further surrounded with blocks 212, 213 of the plate which, in this example, have the same height as the pattern 211.

Such a mold 200 may have been fabricated via a micromachining technique, for example by etching with a solution of TMAH or KOH or an alkaline solution.

The mold 200 and the embossing made by means of the latter may be provided so as to form flared apertures or cavities 108a, 108b which may for example have a frusto-conical shape and respectively reveal the end of the first conducting TSV element 105a, and of a second conducting TSV element 105b.

The cavities 108a, 108b are defined in blocks 109a, 109b of the dielectric material 106 and include walls inclined according to an angle a relatively to a normal n to the main substrate plane (the main plane of the substrate being defined in FIG. 1D as a plane passing through the latter and which is parallel to the plane [O; \vec{i}; \vec{k}] of the orthogonal reference system [O; \vec{i}; \vec{j}; \vec{k}]). Each cavity 108a, 108b includes a variable cross-section, the cross-section taken at the mouth of the cavities being greater than their cross-section taken at their bottom.

At the bottom of the cavities 108a, 108b, ends of the TSV conducting elements 105a, 105b are revealed (FIG. 1D).

It is then possible to achieve removal of the dielectric material residues 106 at the bottom of the cavities 108a, 108b and in the areas of the lower face of the substrate positioned around the block 105a, 105b. This removal may be achieved by dry etching, for example by means of an O₂-based plasma.

Next, the cavities 108a, 108b are filled with conducting material 111 (FIG. 1E). This conducting material 111 may be metal and for example copper. A technique adapted for this filling is auto-catalytic coating commonly called <<electroless plating>>.

The configuration of the cavities 108a, 108b in particular the slope of their walls, gives the possibility of obtaining a filling of better quality for example as compared with cavities which would have a step-shaped profile.

In one case (not shown in the FIGS. 1D-1E) where conducting material growth is achieved by means of conventional electrolysis, it is possible to form before the filling, a layer which may play both the role of a diffusion barrier and a germination layer. Such a layer may be formed with a stack based on Ti and Cu for example by PVD (for <<Physical Vapor Deposition>>) or CVD (for <<Chemical Vapor Deposition>>) covering the walls and the bottom of the cavities 108a, 108b . The slope of the walls of the cavities 108a, 108b facilitates the making of such a germination layer as compared with cavities which would include vertical walls.

Conducting areas 112a, 112b including flanks inclined relatively to a normal to the main substrate plane and which fit the flanks of blocks 109a, 109b of dielectric material 106 are thereby made on the lower face 101 of the support.

Because of the shape of the blocks 109a, 109b and in particular the tilt of the flanks against the inclined flanks of the conducting areas, as well as the type of dielectric material 106 from which these blocks are formed, the blocks 109a, 109b are provided in order to play the role of stress absorbers generated by the material of the areas 112a, 112b. The conducting areas 112a, 112b made have variable cross-section.

According to a particular example, the conducting areas 112a, 112b have a flared shape which may be frusto-conical.

In a case when the step for filling the apertures 108a, 108b is achieved so that the germination layer and the metal filling material jut out from the mouth of the apertures 108a, 108b, a planarization (CMP) step may be carried out in order to remove the excess materials.

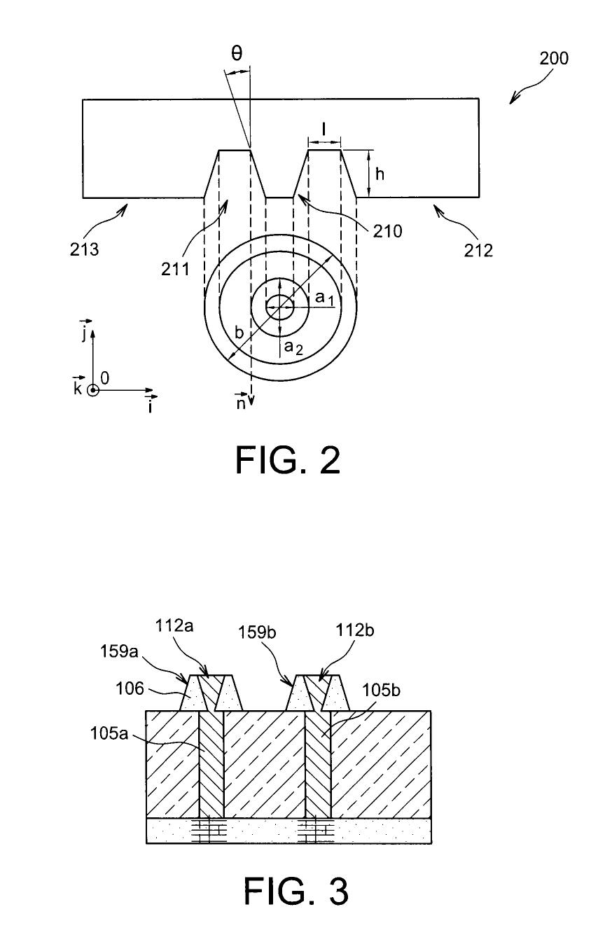

In FIG. 3, an alternative embodiment of the interconnection structure made earlier is given. The conducting areas 112a, 112b surmounting the conducting elements 105a, 105b TSV are surrounded by disconnected blocks 159a, 159b of polymer dielectric material. These blocks 159a, 159b were made by applying a mold (not shown) including a pattern which was applied to a dielectric material area 106 located between the conducting areas 112a, 112b . The blocks 159a, 159b of dielectric material each form a closed contour around a conducting area 112a, 112b and are separated from each other by empty space.

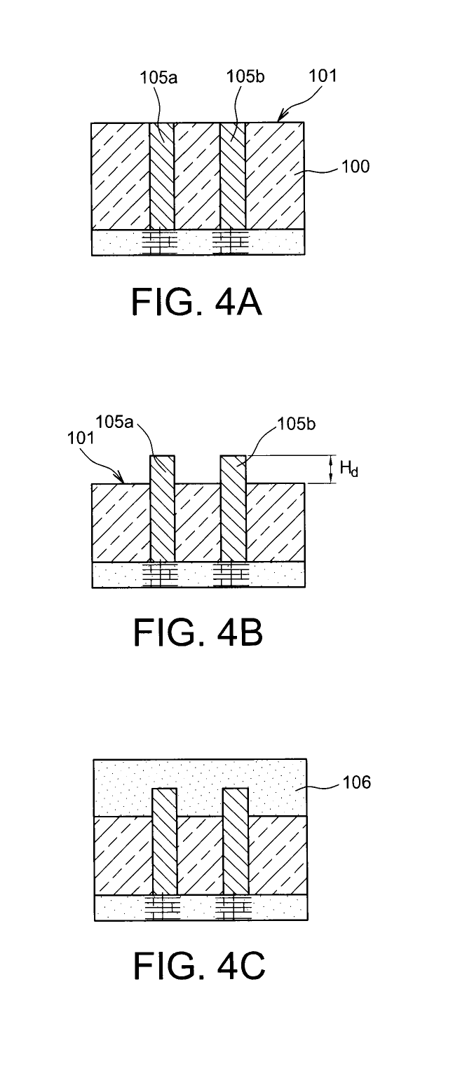

Another exemplary embodiment is given in FIGS. 4A-4E. This method differs from the one described earlier in connection with FIGS. 1A-1E, notably in that removal of a thickness of the substrate 100 is achieved at its rear face 101, so as to release a portion of the TSV elements 105a, 105b which were surrounded with the semi-conducting material of the substrate 100 (FIGS. 4A-4B). At the end of this removal, the conducting elements 105a, 105b have an end which projects beyond from the lower face 101 of the substrate 100.

This removal may be accomplished for example by means of dry etching by plasma. A thickness for example comprised between 1 μm and 10 μm may be removed, so that one end of the conducting elements 105a, 105b projects beyond from the lower face of the substrate 100, along a height H_{d} (measured in FIG. 4B in a direction parallel to the \vec{j} vector of the orthogonal reference system [O; \vec{i}; \vec{j}; \vec{k}] and taken between the lower face 101 of the substrate 100 up to the top of the conducting elements 105a, 105b, for example of the order of 2 μm (FIG. 4B).

The layer of dielectric material 106 is then formed so as to cover the free end of the conducting elements 105a, 105b (FIG. 4C).

Next, cavities are made in this layer by applying a mold 300 including patterns with different heights, in particular recesses or trenches 311a, 311b of respective different depths Δ₁ and A₂ which are applied against the dielectric material 106 (the depths Δ₁ and Δ₂ being measured in FIG. 4D in a direction parallel to the \vec{j} vector of the orthogonal reference system [O; \vec{i}; \vec{j}; \vec{k}]).

The top of the end of the conducting elements 105a, 105b jutting out from the rear face 101 of the substrate 100 may be used as a stopping abutment for the mold 300 with which the imprint is made.

The thickness of the dielectric material layer 106 deposited beforehand, the jutting-out height Hd of the conducting elements 105a, 105b as well as the depth Δ₁, Δ₂ of the pattern 301 of the mold, may have been provided so that when the mold 300 is applied, the top of the conducting elements 105a, 105b (FIG. 4D) is revealed.

The cavities 108a, 108b made with a metal material such as copper are then filled in order to make the conducting areas 122a, 122b forming heads with inclined flanks relatively to a normal n to the main plane of the support 100, in the extension of the end of the conducting elements 105a, 105b.

As compared with a configuration illustrated in FIGS. 1E and 3, the conducting areas 122a, 122b are offset and located at a distance from the rear face of the substrate 100. This configuration gives the possibility of having areas 135 of stress-absorbing dielectric material 106 under the conducting areas 122a, 122b and thereby further limiting the stresses generated within the interconnection structure (FIG. 4E).

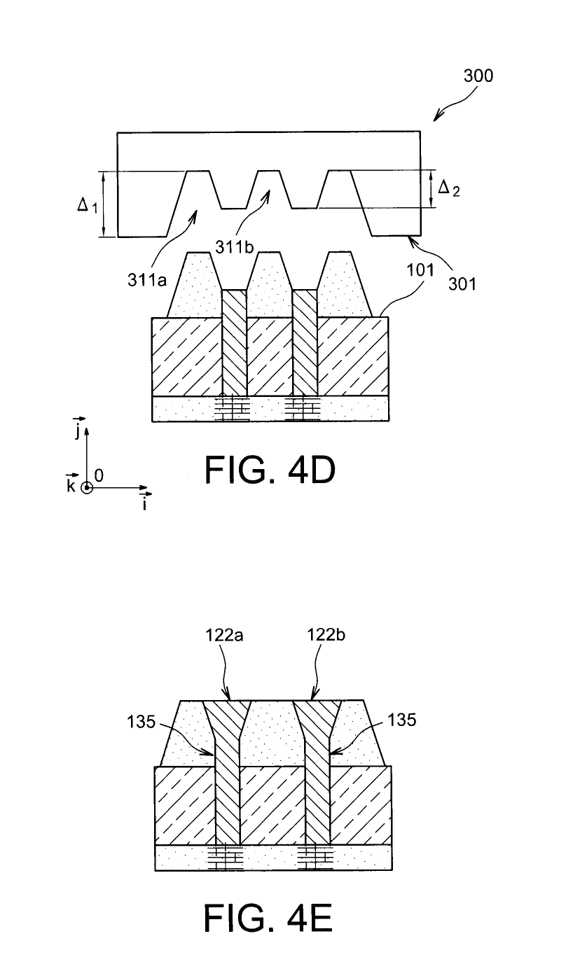

Another exemplary method according to the invention is illustrated in FIGS. 5A-5D. This method differs from the one described earlier with FIGS. 1A-1E, notably because of the embossing step.

This step is carried out by means of a mold 400 allowing formation of the cavities 108a, 108b in the layer of dielectric material 106 including a lower portion 157a, and a lower portion 157b respectively separated from each other by the dielectric material 106 and a common upper portion 158 which surmounts the lower portions 157a, 157b and which is positioned in their extension (FIG. 5A).

Thus, in a single step, by printing by means of the mold 400 in the dielectric material 106 layer, locations are formed for conducting areas in the extension of the TSV elements 105a, 105b, as well as the location for a horizontal conducting line.

A gain in time and cost is achieved as compared with a method in which at least two photolithography steps would have had to be used for making such patterns in the dielectric material 106 layer.

Filling of the cavities 108a, 108b is then carried out by means of a metal material such as copper. This filling leads to the formation of conducting areas 112a, 112b in the extension of the conducting elements 105a, 105b and of a horizontal conducting line 162 above and in the extension of the conducting areas 112a, 112b (FIG. 5B).

Next, on the horizontal conducting line 162, a conducting pad 170 is made. This pad 170 may be made with a first conducting area 164, for example based on copper, on which a second conducting layer 166 formed on the first conducting layer 164 is stacked and which may be based on a brazing alloy for example SnAg.

This bi-layer may be formed by electrolysis. An annealing step in an oven may allow a hemispherical shape to be given to the second conducting area 166 (FIG. 5C).

Next, it is optionally possible to cover the conducting line 162 with a dielectric material 176, for example a polymeric material of the same type as the one used for forming the dielectric layer 106. The conducting line 162 is then encapsulated (FIG. 5D).

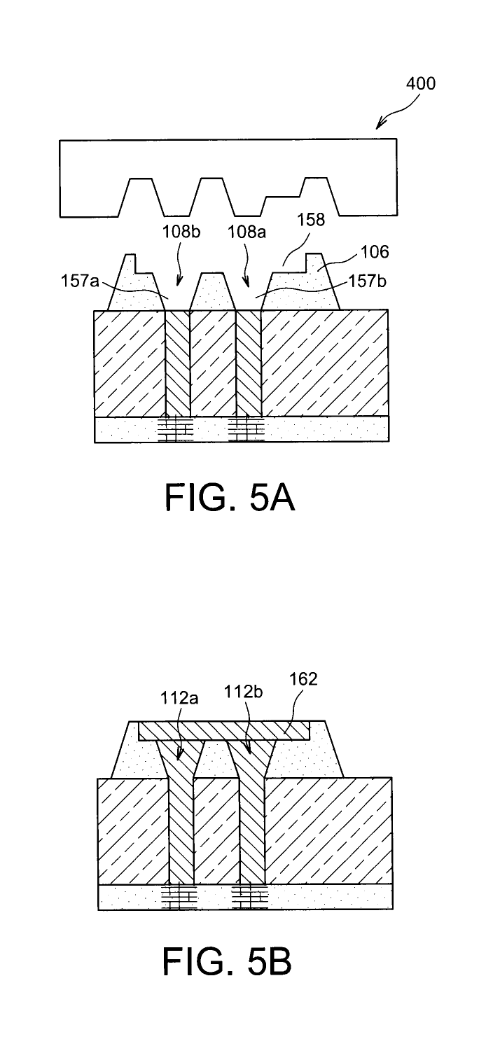

According to a particular application of the exemplary method described earlier, and particularly of the horizontal conducting line 162, it is possible to carry out first of all the filling of the cavities 108a, 108b by means of a metal material, so as to form the conducting areas 112a, 112b , while the upper portion 158 is not filled (FIG. 6A).

Next, a germination layer 151 is formed followed by masking 155 of the resin revealing the trench 158 (FIG. 6B). Steps (not shown) for electrochemical deposition (ECD) of metal, for removing the resin masking 155, and then optionally for planarization or mechano-chemical polishing (CMP) so as to remove the excess metal, with stopping on the dielectric layer, may then be carried out for forming the conducting line 162.

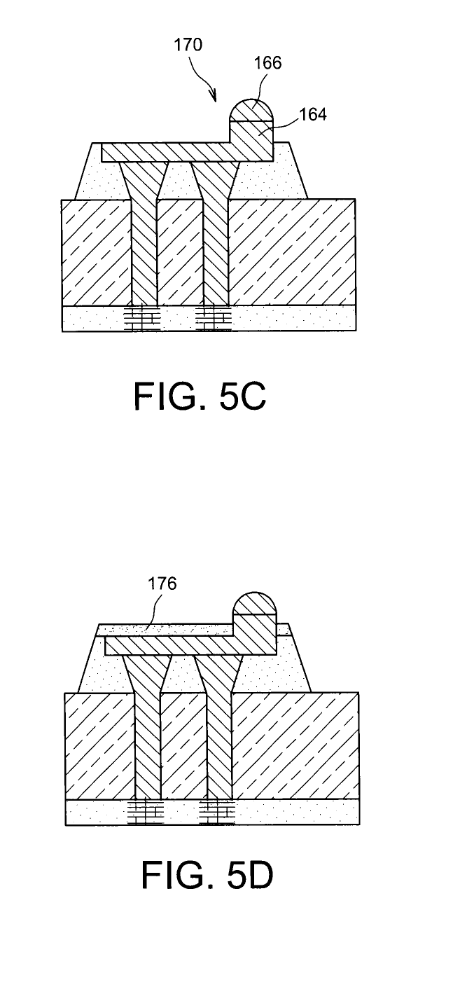

An alternative structure made according to the invention is given in FIG. 7.

This structure is formed on a support comprising a semi-conducting substrate 100 provided on its other face with components forming a circuit C and with metal levels N₁, . . . , Nₖ of interconnections of the components.

A TSV interconnection element 505 crosses the thickness of the substrate 100 and allows establishment of an electric connection between the circuit located on the front face 101 of the support and on the rear face 102 of the latter.

A conducting pad 515, for example based on aluminum is positioned on the front face 101 of the support above the metal interconnection levels. This conducting pad is connected to the circuit C and is surmounted with a block 509 for absorbing stresses, based on the dielectric material 106. The block 509 includes an aperture, the walls of which are inclined relatively to a normal ii to the substrate main plane according to an angle α.

This conducting area 512 may have been made from a nucleation layer covering the walls and the bottom of a cavity and then growing a metal material such as copper so as to fill this cavity. The conducting area 512 thus includes inclined flanks fitting those of the block 509 of the dielectric material 106. The conducting area 512 is also surmounted with a stack formed by a metal area 562, for example based on copper, on which another area 564 having a hemispherical or bump shape is made.

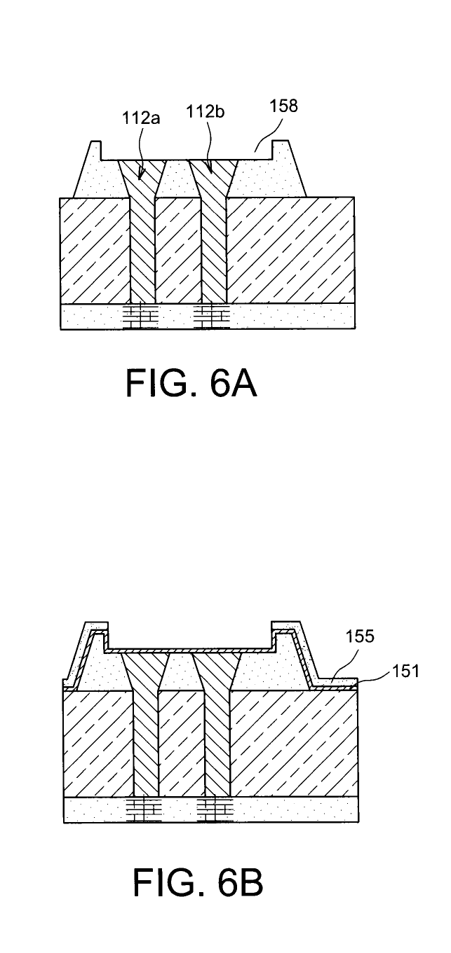

An alternative embodiment of contacting structure is given in FIG. 8.

For this alternative, blocks 609a, 609b for isolation and reduction of stress, based on a dielectric material and having different shapes and different sizes are formed around conducting areas 612a, 612b on the same face of a support 600. The blocks 609a, 609b are according to their shapes and to their dimensions dependent on the distribution of the stresses on the support 600, which may for example be a chip including several metal interconnection levels.

The blocks 609a, 609b may be based on a polymeric material or on SiO₂ and were formed by embossing by means of a mold, according to a technique similar to the one described earlier in connection with FIG. 1C.

The conducting areas 612a, 612b are in this example made on conducting elements 605a, 605b in the form of pads connected to the metal interconnection levels. The conducting areas 612a, 612b include a lower portion having a variable cross-section which increases from the base to its top and fits the shape of the block 609a, 609b.

The conducting areas 612a, 612b further include an hemispherical upper portion resting on the lower portion.

In an area R₂ located at the periphery of the chip in which the stresses are greater, a conducting element 612b is surrounded by a block 609b for isolating and reducing stresses, with a height H₂, provided with inclined flanks according to an angle α₂ relatively to the normal h to the main plane of the support 600, and thus having a critical width or size I₂ measured in a direction parallel to a plane [O; \vec{i}; \vec{k}] of the reference system [O; \vec{i}; \vec{j}; \vec{k}]), variable in a direction parallel to the normal h .

In another area R₁ located at the center of the chip and in which the stresses are smaller, and where a larger density of integration of components is preferred, a conducting element 612a is surrounded by a block 609a for isolation and reduction of stresses, with a height H₁ such that H₁<H₂, with a critical width or size I₁ such that I₁<I₂ and provided with inclined flanks according to an angle α₁ such that α₁>α₂.

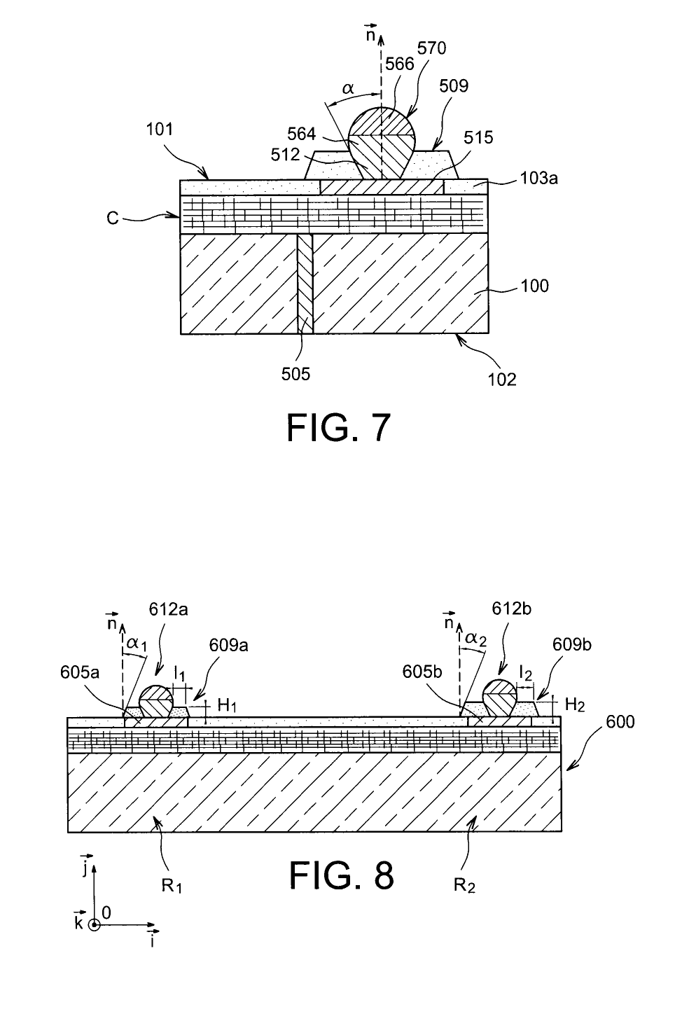

Another alternative embodiment is given in FIG. 9.

For this alternative, conducting areas 712a, 612b of different types are provided on a same face of a support on the interposer type. The conducting areas 712a of smaller size are intended to be connected to a first type of device, for example a motherboard while the conducting area 612b of larger sizes are surrounded with blocks 709a of dielectric material with a larger thickness intended to be connected to a second type of device, for example a chip.

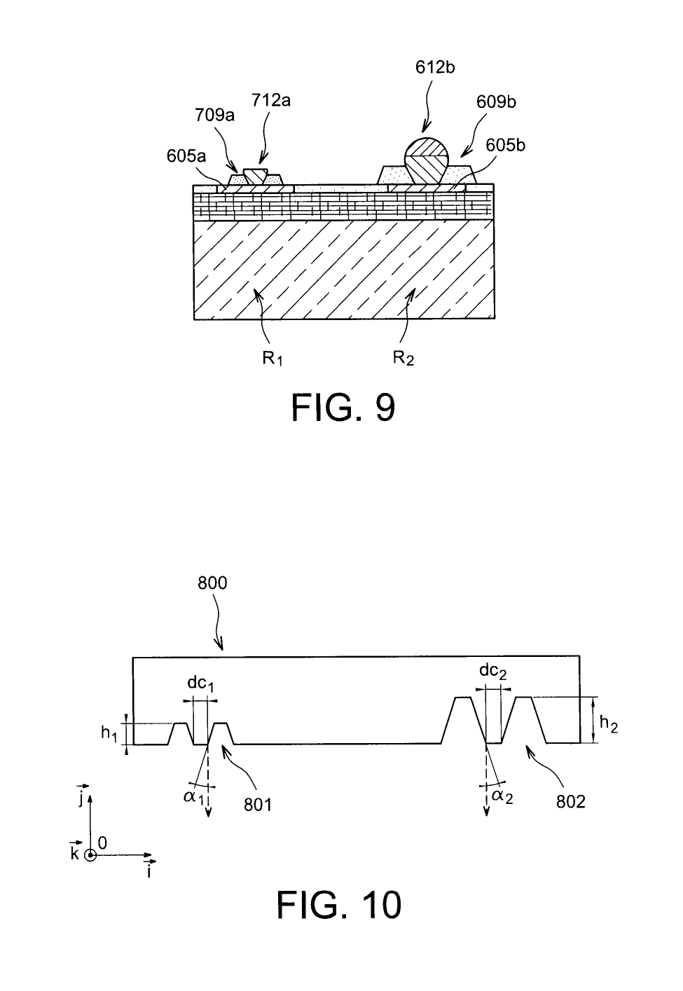

In order to produce the blocks 609b, 709a of the dielectric material, a nano-imprint mold 800 of the type of the one illustrated in FIG. 10 may have been used. This mold 800 appears as a plate including patterns 801, 802 protruding on the plate and provided with inclined flanks relatively to a normal \vec{n} to the main plane of the plate (the main plane of the plate being a plane passing through the plate and parallel to the plane [O; \vec{i}; \vec{k}] of the reference system [O; \vec{i}; \vec{j}; \vec{k}] in FIG. 10).

The patterns 801, 802 of the mold 800 have a decreasing cross-section from their base to their top.

In this example, the plate 800 includes a first pattern 801 with a height h₁, of a critical size dc₁, as well as a second pattern 802 of height h₂>h₁, of a critical size dc₂>dc₁. The tilt of the flanks of the second pattern 802 is also different from the one of the flanks of the first pattern 801.

1. A method for making at least one contacting structure comprising a conducting area positioned on one face of a support, the method comprising steps consisting of:
removing a thickness a support face in order to release one end of a conducting element, said conducting element at least partially crossing the thickness of the support and including an end which is flush on said face or projects beyond from said face of the support,
forming on said face of the support, at least one area based on a dielectric material on said conducting element,
forming in said dielectric materials at least one first block of dielectric material including a first cavity provided with inclined walls relatively to a normal to the main plane of said support and a bottom revealing said conducting element, this step being at least achieved by applying a mold on said area of dielectric material,
filling said cavity with a conducting material so as to form a conducting area in the extension of said conducting element.

2. The method according to claim 1, wherein, in step a), said given face of the support includes at least one portion of a second conducting element, and wherein the application of the mold is accomplished so that at least one second block of dielectric material including at least one second cavity reveals said second conducting element.

3. The method according to claim 2, wherein the application of the mold is carried out so that said first block of dielectric material and said second block of dielectric material belong to a same area of dielectric material or are separated by an empty space.

4. The method according to claim 2, wherein said first cavity and said second cavity have upper portions communicating with each other.

5. The method according to claim 2, wherein the application of the mold is achieved so that said first block of dielectric material and said second block of dielectric material are of different sizes.

6. The method according to claim 2, wherein the application of the mold is achieved so that said first block of dielectric material and said second block of dielectric material have inclined flanks relatively to a normal to the main plane of said support, the tilt of the flanks of said first block being different from that of the flanks of said second block.

7. The method according to claim 1, wherein, between the step for forming the first block including the first cavity and the step for filling the first cavity, a germination layer is formed on the walls and the bottom of the first cavity, the filling step being achieved by growth on the germination layer.

8. An embossing mold adapted to the carrying out of the step for applying the mold to a method according to claim 1, in the form of another support having at least one given pattern protruding on said other support, said given pattern having a cross-section decreasing from its base to its top and inclined flanks.

9. The embossing mold according to claim 8, having at least one other protruding pattern, said other pattern including flanks with a different tilt from that of the flanks of said given pattern, or with dimensions different from that of said given pattern or with flanks of a tilt different from the one of the flanks of said given pattern and with dimensions different from those of said given pattern.
